(19) United States
(12) Patent Application Publication
(10) Pub. No.: US 2024/0239402 A1
(43) Pub. Date: Jul. 18, 2024

(54) Adjusting Device and Method for Automatically Adjusting a Worm on a Worm Wheel of a Worm Gear for an Electromechanical Auxiliary Power Steering System for a Vehicle

(71) Applicant: KNORR-BREMSE Systeme fuer Nutzfahrzeuge GmbH, Muenchen (DE)

(72) Inventor: Sven OSELKA, Mettmann (DE)

(21) Appl. No.: 18/558,975

(22) PCT Filed: Apr. 22, 2022
(86) PCT No.: PCT/EP2022/060743

§ 371 Date: Nov. 3, 2023

(30) Foreign Application Priority Data
May 5, 2021 (DE) 10 2021 111 600.7

(51) Int. Cl. B62D 5/04; F16H 55/24

(52) U.S. Cl. CPC B62D 5/0454; F16H 55/24

(57) ABSTRACT

An adjusting device for automatically adjusting a worm on a worm wheel of a worm gear for an electromechanical auxiliary power steering system for a vehicle, includes a spring, a guide linkage, and a pressure piece. The spring is shaped so as to exert a spring force onto the guide linkage in order to radially push the guide linkage towards the worm. The guide linkage is designed to transmit the spring force onto the pressure piece. The pressure piece, which is connected to the guide linkage, is designed to contact a worm section of the worm in order to exert an adjusting force, which is produced by the spring force, onto the worm. The adjusting device additionally has a clamping device which is designed to prevent the guide linkage from moving back away from the worm.

### BACKGROUND AND SUMMARY

The present disclosure relates to an adjusting device for automatically adjusting a worm on a worm wheel of a worm gear for an electromechanical auxiliary power steering system for a vehicle, an electromechanical auxiliary power steering system, and a method for adjusting a worm on a worm wheel of a worm gear.

DE 10 2012 103 857 A1 describes a device for pushing a worm or a helical pinion onto a worm wheel or onto a helical wheel. The worm is pushed in the axial direction onto the worm wheel.

Against this background, the object of the present disclosure is to provide an improved adjusting device for automatically adjusting a worm on a worm wheel of a worm gear for an electromechanical auxiliary power steering system for a vehicle, an improved electromechanical auxiliary power steering system, and an improved method for adjusting a worm on a worm wheel of a worm gear.

This object is achieved by an adjusting device, an electromechanical auxiliary power steering system, and a method having the features of the independent claims.

The advantages which can be achieved by the approach set forth above consist in providing a possibility for automatically adjusting a worm on a worm wheel, functioning in a stable manner by using few components, so that the gearing partners of the worm gear are kept free of play.

An adjusting device for automatically adjusting a worm on a worm wheel of a worm gear for an electromechanical auxiliary power steering system for a vehicle has a spring, a guide linkage and a pressure piece. The spring is shaped so as to exert a spring force on the guide linkage, in order to radially push the guide linkage towards the worm. The guide linkage is designed to transmit the spring force onto the pressure piece. The pressure piece, which is connected to the guide linkage, is designed to contact a worm section of the worm in order to exert an adjusting force, which is produced by the spring force, onto the worm. The adjusting device also has a clamping device which is designed to prevent the guide linkage from moving back away from the worm. In this manner, the guide linkage can be moved in only one direction, namely towards the worm, for example in order to compensate for wear.

The worm can be mounted so as to be able to oscillate, for example, in a self-aligning bearing. The spring can be a spiral spring. The spring can be clamped in a tensioned state between a housing element and a pin on the guide linkage in order to exert the spring force onto the guide linkage. The guide linkage can be shaped in a rod-shaped manner, for example cylindrically. The pin can extend from the guide linkage perpendicularly to an axis of extension of the cylindrical guide linkage. The spring can be arranged so as to be wound around an end section of the guide linkage remote from the pressure piece and can be supported at one spring end on the pin and at an opposing spring end on the housing element. The worm can be shaped in a wave-shaped manner and/or have a threaded section with a worm thread for meshing with the worm wheel. The worm section, which is shaped for contact with the pressure piece, can be cylindrically shaped and/or form an end section of the worm. The guide linkage and the worm can be oriented so as to run perpendicularly to one another such that, when the worm is adjusted, the adjusting force is exerted radially onto the worm section. The clamping device can advantageously serve to adjust wear on the pressure piece, by preventing the guide linkage from moving back in a direction opposing the adjusting force. The adjusting path which is present due to the wear is thus repeatedly re-adjusted without relatively increasing, since resetting is prevented by the clamping device on the linkage. The adjusting device set forth herein advantageously permits in a simple manner an automatic radial adjustment of the worm on the worm wheel by using the spring force.

A contact surface of the pressure piece can be shaped in a curved manner for contact with the worm section. Thus, the pressure piece can encompass a cylindrical surface of the worm section in a stable manner, for example within a tolerance range of 20% deviation by 160°.

According to one embodiment, it is also advantageous if the pressure piece has a resilient element for coupling the pressure piece to the guide linkage. The resilient element can be formed as an elastomer insert, the Shore Hardness thereof being able to be set in a variable manner. Such a resilient element can absorb in a resilient manner distortion of the gearing partners and thus prevent rattling and jamming during the operation of the worm gear. According to one embodiment, a section of the contact surface can have such a resilient element.

According to one embodiment, the clamping device can be designed to prevent a deflection of the pressure piece and/or the worm caused by separating forces which result from the gearing between the worm and the worm wheel during the operation of the worm gear. Such a clamping device can reinforce the spring force, so that the gearing partners of the worm gear are securely held together during operation in spite of the separating forces.

The adjusting device can also have a housing section with a through-opening through which the guide linkage is guided. The housing section can be formed as a fixed housing section and/or can be fixedly connected to the housing element. The guide linkage can be stabilized in the through-opening so that, for example, the guide linkage is prevented from being tilted to the side.

According to one embodiment, an opening section of the through-opening can be conically shaped, at least one wedge of the clamping device can be arranged in the opening section and a further spring of the clamping device can be clamped between the wedge and the pressure piece. Thus, a practical implementation of a clamping device can be carried out.

According to one embodiment, the opening section can have an inclined plane for positively receiving the wedge. The opening section can have a larger diameter in a region facing the pressure piece than in a region remote from the pressure piece. The further spring can serve to secure a position of the wedge by the further spring centering the wedge in the through-opening. The further spring can have a smaller spring force, spring length and/or a smaller spring diameter than the spring. Thus, an adjustment of the worm is made possible via the spring mechanism in combination with the wedge principle, so that the adjustment path which is present due to the wear is repeatedly re-adjusted without relatively increasing, since resetting is prevented by the action of the wedge on the linkage. Thus, the resilient compensation path of the worm remains constant, even after lengthy use and increased wear.

Assuming that in the new state a resilient path of 0.5 mm is permitted via the elastomer or another structure, and this path would increase to 1 mm due to wear on the worm wheel, a play of 1 mm would then be present on the gear as a result. By re-adjusting the linkage via the spring force and preventing a reverse movement via the wedge on the linkage, the path is re-adjusted again and the gear now only has the possibility of deflecting by 0.5 mm in the resilient region. By re-adjusting the linkage via the spring force and preventing a reverse movement via the wedge, the path is re-adjusted again and the gear now only has the possibility of deflecting by 0.5 mm.

According to one embodiment, it is also advantageous if the adjusting device has two conical half-shells which form the wedge. The half-shells can thus clamp the guide linkage from two opposing sides. A clamping force of the half-shells acting on the guide linkage can be proportional to the worm separating force and thus can be self-reinforcing.

The two half-shells can be structurally the same and/or can be arranged opposite one another in the conical, for example funnel-shaped, opening section.

The wedge can also have a bore through which the guide linkage is guided. The bore can be arranged between the half-shells and/or wherein the diameter thereof can be slightly smaller than the diameter of the guide linkage. Thus, a clamping force can be exerted on the guide linkage.

The adjusting device can also have a bearing device with a bearing slot in which the worm section is received. The bearing slot can be oriented according to the operating direction of the spring force/adjusting force. Such a slot ensures a radial guidance of the worm and, for example, permits only the degree of freedom in the direction of the worm wheel.

According to one embodiment, the adjusting device can also comprise the worm and/or the worm wheel, wherein the worm is mounted so as to be able to oscillate in a self-aligning bearing. Thus, a comprehensive and complete system consisting of the worm gear and the automatic adjusting device is provided.

An electromechanical auxiliary power assisted steering system comprising a motor and a steering linkage has an adjusting device which couples the motor and the steering linkage and which is formed in one of the variants described above. Such an electromechanical auxiliary power assisted steering system permits an automatic adjustment of the worm of a worm gear of the auxiliary power assisted steering system. The steering linkage can thus be moved without play.

A method for automatically adjusting a worm on a worm wheel of a worm gear for an electromechanical auxiliary power assisted steering system for a vehicle has an exertion step, a transmission step, a contact step and a prevention step. In the exertion step, a spring force of a spring is exerted on a guide linkage in order to radially push the guide linkage towards the worm. In the transmission step, the spring force is transmitted from the guide linkage to a pressure piece connected to the guide linkage. In the contact step, the pressure piece is brought into contact with a worm section of the worm in order to exert an adjusting force, which is produced by the spring force, onto the worm. In the prevention step, the guide linkage is prevented from moving back away from the worm.

This method can be carried out, for example, by using the above-described adjusting device.

Exemplary embodiments of the approach set forth herein are explained in more detail in the following description, with reference to the figures.

### BRIEF DESCRIPTION OF THE DRAWINGS

FIG. 1 is a schematic view of an adjusting device for automatically adjusting a worm on a worm wheel of a worm gear for an electromechanical auxiliary power assisted steering system for a vehicle according to an exemplary embodiment;

FIG. 2 is a schematic view of a bearing device of an adjusting device according to an exemplary embodiment;

FIG. 3 is a schematic view of a vehicle having an electromechanical auxiliary power assisted steering system with an adjusting device according to an exemplary embodiment; and

FIG. 4 is a flow diagram of a method for automatically adjusting a worm on a worm wheel of a worm gear for an electromechanical auxiliary power assisted steering system for a vehicle according to an exemplary embodiment.

In the following description of advantageous exemplary embodiments of the present approach, the same or similar reference signs are used for the elements which are shown in the various figures and which act in a similar manner, wherein a repeated description of these elements is dispensed with.

### DETAILED DESCRIPTION OF THE DRAWINGS

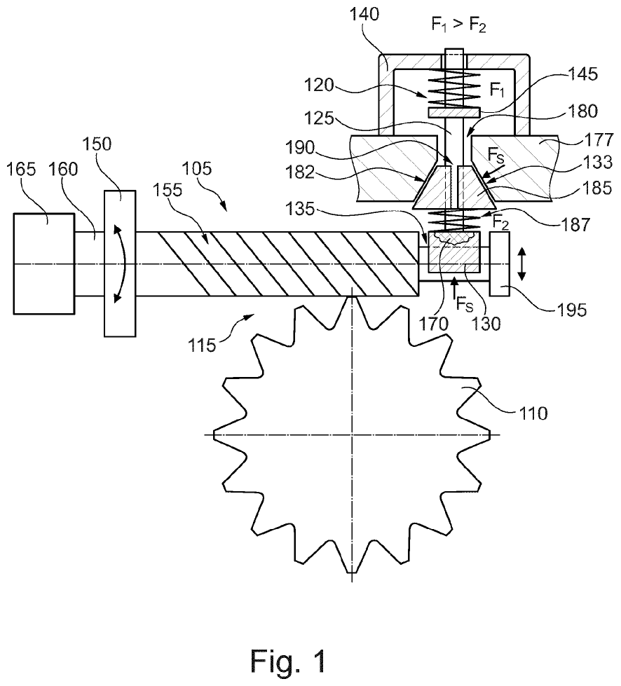

FIG. 1 is a schematic view of an adjusting device 100 for automatically adjusting a worm 105 on a worm wheel 110 of a worm gear 115 for an electromechanical auxiliary power assisted steering system for a vehicle according to an exemplary embodiment.

The adjusting device 100 has a spring 120, a guide linkage 125, a pressure piece 130 and a clamping device 133. The spring 120 is shaped so as to exert a spring force F1 on the guide linkage 125 in order to radially push the guide linkage 125 towards the worm 105. The guide linkage 125 is designed to transmit the spring force F1 onto the pressure piece 130. The pressure piece 130, which is connected to the guide linkage 125, is designed to contact a worm section 135 of the worm 105 in order to exert an adjusting force, which is produced by the spring force F1, onto the worm 105. The clamping device 133 is designed to prevent the guide linkage 125 from moving back away from the worm 105.

According to this exemplary embodiment, the spring 120 is clamped in a tensioned state between a housing element 140 and a pin 145 on the guide linkage 125 for exerting the spring force F1 on the guide linkage 125. As an alternative to the pin 145, a further suitable stop element for the spring 120 can also be used. According to this exemplary embodiment, the spring 120 is a spiral spring.

According to this exemplary embodiment, the worm 105 is mounted so as to be able to oscillate in a self-aligning bearing 150. According to this exemplary embodiment, the worm 105 is shaped in a wave-shaped manner and/or has a threaded section with a worm thread 155 for meshing with the worm wheel 110. According to this exemplary embodiment, the worm section 135 which is shaped for contact with the pressure piece 130 is shaped cylindrically and/or as an end section of the worm 105. According to this exemplary embodiment, an end section of the worm 105 opposing the end section is coupled in the form of a motor shaft 160 to the motor 165.

When the motor 165 is activated, the worm 105 is rotated about its axis of extension and rotates the worm wheel 110 due to the gearing of the worm thread 155 with the worm wheel 110. The adjusting device 100 advantageously serves to keep this gearing free of play.

According to this exemplary embodiment, the guide linkage 125 is shaped in a rod-shaped manner, in this case cylindrically. According to this exemplary embodiment, the pin 145 extends perpendicularly to the axis of extension of the cylindrical guide linkage 125 on at least two sides away from the guide linkage 125. According to this exemplary embodiment, the spring 120 is arranged so as to be wound about an end section of the guide linkage 125 remote from the pressure piece 130 and is supported at one spring end on the pin 145 and at an opposing spring end on the housing element 140. According to this exemplary embodiment, the guide linkage 125 and the worm 105 are oriented so as to run perpendicularly to one another, so that when the worm 105 is adjusted the adjusting force is exerted radially onto the worm section 135 from one side of the worm 105 remote from the worm wheel 110.

According to this exemplary embodiment, a contact surface of the pressure piece 130 is shaped in a curved manner for contact with the worm section 135. Thus according to this exemplary embodiment, the pressure piece 130 partially encompasses a cylindrical surface of the worm section 135, for example within a tolerance range of 20% deviation by 160°. According to an exemplary embodiment, a curvature of the contact surface of the pressure piece is shaped in a concave manner and is adapted to a shape of an external surface of the worm section 135.

According to an exemplary embodiment, the pressure piece 130 also has a resilient element 170 for coupling the pressure piece 130 to the guide linkage 125. According to this exemplary embodiment, the resilient element 170 is formed as an elastomer insert. According to an exemplary embodiment, a Shore Hardness of the resilient element 170 can be adjusted in a variable manner, for example by a suitable choice of material. According to an exemplary embodiment, the resilient element 170 is arranged in a cut-out or through-opening of the pressure piece 130 arranged opposite the guide linkage 125. According to an exemplary embodiment, a section of the contact surface is shaped by the resilient element 170. Additionally or alternatively, according to an exemplary embodiment a connecting surface between a free end of the guide linkage 125 and the pressure piece 130 is shaped by the resilient element 170.

According to this exemplary embodiment, the clamping device 133 is designed to prevent a deflection of the pressure piece 130 and/or the worm 105 caused by the separating forces Fs, which result from the gearing between the worm 105 and the worm wheel 110 during the operation of the worm gear 115.

According to this exemplary embodiment, the adjusting device 100 also has a housing section 177 with a through-opening 180 through which the guide linkage 125 is guided. According to this exemplary embodiment, the housing section 177 is shaped as a fixed housing section and/or is fixedly connected to the housing element 140. According to an exemplary embodiment, the motor 165 and/or the housing section 177 and/or the housing element 140 are fastened rigidly to a vehicle body of the vehicle. According to this exemplary embodiment, an opening section 182 of the through-opening 180 is conically shaped, and the adjusting device 100 has at least one wedge 185 of the clamping device 133 arranged in the opening section 182 and a further spring 187 of the clamping device 133 which is clamped between the wedge 185 and the pressure piece 130. According to this exemplary embodiment, the opening section 182, the wedge 185 and the further spring 187 produce the aforementioned clamping device 133 which according to this exemplary embodiment is arranged between the spring 120 and the pressure piece 130. According to this exemplary embodiment, the opening section 182 has an inclined plane. The opening section 182 has a larger diameter in a region facing the pressure piece 130 than in a region remote from the pressure piece 130. According to this exemplary embodiment, the further spring 187 has a smaller spring force F2 than the spring 120. According to an exemplary embodiment, two conical half-shells are used as the wedge 185. A clamping force of the half-shells acting on the guide linkage 125 is proportional to the worm separating force Fs and thus is self-reinforcing. According to this exemplary embodiment, the two half-shells are arranged opposite one another in the conical, for example funnel-shaped, opening section 182.

According to an exemplary embodiment, the half-shells which form the wedge 185 have a bore 190 through which the guide linkage 125 is guided. According to this exemplary embodiment, the bore 190 is arranged between the half-shells. According to an exemplary embodiment, a diameter of the bore 190 is slightly smaller than the diameter of the guide linkage 125. As a result, the guide linkage 125 is clamped in the bore 190 when the wedge 182 is pushed by the further spring 187 against the conically shaped opening section 182 of the through-opening 180 of the housing section 177. This clamping of the guide linkage 125 is released when the guide linkage 125 moves in the direction of the worm 105, for example for compensating for wear. As soon as the wedge 182 is pushed back against the opening section 182, the guide linkage 125 is clamped again so that the guide linkage 125 cannot move in the opposing direction, i.e. away from the worm 105.

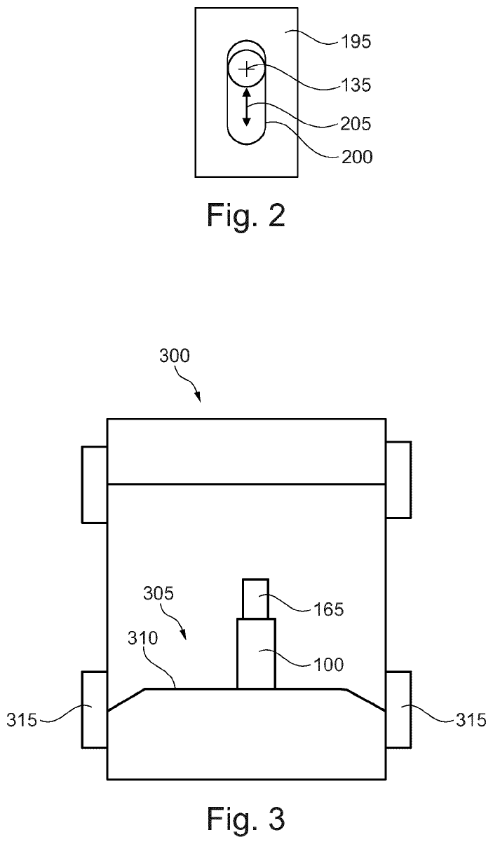

According to this exemplary embodiment, the adjusting device 100 also has a bearing device 195 with a bearing slot in which the worm section 135 is received. The bearing device 195 is described in more detail in FIG. 2.

According to an exemplary embodiment, the adjusting device 100 also comprises the worm 105 and/or the worm wheel 110, wherein the worm 105 is mounted so as to be able to oscillate in the self-aligning bearing 150.

The adjusting device 100 set forth herein permits an automatic adjustment of a worm gear 115 which can be used, for example, in an electromechanical auxiliary power assisted steering system for the automobile industry.

A goal of the adjusting device 100 is to keep the gearing partners of the worm gear 115 free of play over the service life and to adjust the wear permanently so that only a resilience between the gearing partners is maintained. The reasons for this are NVH (noise, vibration, harshness) and control requirements for the worm gear 115.

To this end, according to an exemplary embodiment the worm 105 is mounted in an oscillating manner about the motor 165 and is able to be fed radially in the direction of the worm wheel 110. According to an exemplary embodiment, the bearing slot shown in FIG. 2 is arranged on an opposing bearing point and ensures a radial guidance of the bearing and permits only one degree of freedom in the direction of the worm wheel 110.

The worm section 135 is arranged on the worm 105 in the form of a cylindrical projection as a support point for the pressure piece 130, which encompasses the cylindrical surface by approximately 160° and introduces the adjusting force into the worm 105. According to an exemplary embodiment, this pressure piece 130 comprises the resilient element 170 in the form of an elastomer insert, the Shore Hardness thereof being able to be set in a variable manner. The elastomer insert is designed to absorb in a resilient manner distortion of the gearing partners and thus prevents rattling and/or jamming. The elastomer insert is designed to compensate here for concentricity errors in the worm 105.

The pressure piece 130, which can also be denoted as a “yoke”, is connected to the guide linkage 125. According to an exemplary embodiment, the guide linkage 125 is guided in the housing section 177 in the form of a fixed housing and is pushed together with the pressure piece 130 by the spring 120 in the direction of the worm wheel 110.

In the case of wear between the gearing partners, the worm 105 is adjusted by the spring force F1 of the spring 120 in a guaranteed manner. In order to prevent the deflection of the pressure piece 130 and thus the worm 105 caused by the separating forces Fs, which result from the gearing, according to this exemplary embodiment a clamping mechanism is implemented by the clamping device 133. According to an exemplary embodiment, the clamping device 133 consists of a conical bore in the housing, previously denoted as the opening section 182, and two conical half-shells with a bore 190 between the half-shells, the diameter thereof being slightly smaller than the diameter of the guide linkage 125.

According to an exemplary embodiment, the guide linkage 125 is located in the bore 190 between the conical half-shells which are arranged in the housing section 177 such that in the case of a deflection movement of the worm 105 they are clamped via the angle of the cone by the separating force Fs, and thus can be moved freely only in the direction of the worm wheel 110. The clamping force of the half-shells acting on the guide linkage 125 is proportional to the worm separating force Fs and thus is self-reinforcing. The further spring 187 which centers the conical half-shells in the through-opening 180 of the housing section 177 is provided in order to secure the position of the half-shells.

According to an exemplary embodiment, the spring force F1 of the spring 120 and/or a spring length and/or a spring diameter of the spring 120 are greater than the spring force F2 of the further spring 187 and/or a spring length and/or a spring diameter of the further spring 187. According to an exemplary embodiment, the springs 120/187 and/or spring forces F1/F2 are very small since they are intended only to secure the position of the clamping half-shells.

FIG. 2 shows a schematic view of a bearing device 195 of an adjusting device according to an exemplary embodiment. This can be the bearing device, described with reference to FIG. 1, of the adjusting device 195 described in FIG. 1.

The bearing device 195 is shown rotated by 90° to the observer, relative to the view shown in FIG. 1, so that the bearing slot 200 can be viewed from the front. According to this exemplary embodiment, the bearing slot 200 is oriented according to the operating direction 205 of the spring force/adjusting force. An adjustment of the worm via the worm section is thus permitted only in the direction of the worm wheel 135.

FIG. 3 shows a schematic view of a vehicle 300 with an electromechanical auxiliary power steering system 305 with an adjusting device 100 according to an exemplary embodiment. This can be an electromechanical auxiliary power steering system 305 and/or adjusting device 100 described with reference to FIG. 1.

The electromechanical auxiliary power steering system 305 comprises the motor 165 described in FIG. 1, a steering linkage 310, and the adjusting device 100 which couples the motor 165 and the steering linkage 310. According to this exemplary embodiment, the steering linkage 310 connects two vehicle wheels 315 assigned to a wheel axle of the vehicle 300. Due to the adjusting device 100, the steering linkage 310 can be moved without play.

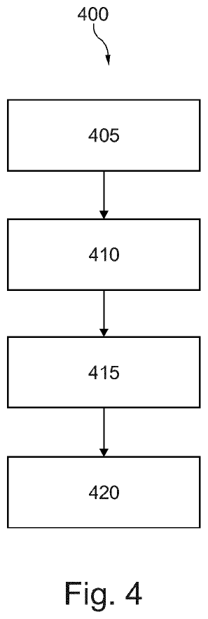

FIG. 4 shows a flow diagram of a method 400 for automatically adjusting a worm on a worm wheel of a worm gear for an electromechanical auxiliary power steering system for a vehicle according to an exemplary embodiment. This can be a method 400 which can be carried out by using the adjusting device described in one of the preceding figures.

The method 400 has an exertion step 405, a transmission step 410, a contact step 415 and a prevention step 420. In the exertion step 405, a spring force of a spring is exerted on a guide linkage in order to radially push the guide linkage towards the worm. In the transmission step 410, the spring force is transmitted from the guide linkage to a pressure piece connected to the guide linkage. In the contact step 415, the pressure piece is brought into contact with a worm section of the worm in order to exert an adjusting force, which is produced by the spring force, onto the worm. In the prevention step 420 the guide linkage is prevented from moving back away from the worm.

### REFERENCE SIGNS

F1 Spring force of spring
F2 Spring force of further spring
Fs Separating force
100 Adjusting device
105 Worm
110 Worm wheel
115 Worm gear
120 Spring
125 Guide linkage
130 Pressure piece
133 Clamping device
135 Worm section
140 Housing element
145 Pin
150 Self-aligning bearing
155 Worm thread
160 Motor shaft
165 Motor
170 Resilient element
177 Housing section
180 Through-opening
182 Opening section
185 Wedge
187 Further spring
190 Bore
195 Bearing device
200 Bearing slot
205 Operating direction
300 Vehicle
305 Electromechanical auxiliary power steering system
310 Steering linkage
315 Vehicle wheel
400 Method for automatically adjusting a worm on a worm wheel of a worm gear for an electromechanical auxiliary power steering system for a vehicle
405 Exertion step
410 Transmission step
415 Contact step
420 Prevention step

1.-12. (canceled)

13. An adjusting device for automatically adjusting a worm on a worm wheel of a worm gear for an electromechanical auxiliary power steering system for a vehicle, the adjusting device comprising:
a guide linkage;
a pressure piece;
a spring which is shaped so as to exert a spring force onto the guide linkage in order to radially push the guide linkage towards the worm;
wherein the guide linkage is configured to transmit the spring force onto the pressure piece′
wherein the pressure piece, which is connected to the guide linkage, is configured to contact a worm section of the worm in order to exert an adjusting force, which is produced by the spring force, onto the worm; and
a clamping device configured to prevent the guide linkage from moving back away from the worm.

14. The adjusting device as claimed in claim 13, wherein
a contact surface of the pressure piece is shaped in a curved manner for contact with the worm section.

15. The adjusting device as claimed in claim 13, wherein
the pressure piece has a resilient element for coupling the pressure piece to the guide linkage.

16. The adjusting device as claimed in claim 13, wherein
the clamping device is configured to prevent a deflection of the pressure piece and/or the worm caused by separating forces which result from gearing between the worm and the worm wheel during operation of the worm gear.

17. The adjusting device as claimed in claim 13, further comprising:
a housing section with a through-opening through which the guide linkage is guided.

18. The adjusting device as claimed in claim 17, wherein
an opening section of the through-opening is conically shaped,
at least one wedge of the clamping device is arranged in the opening section, and
a further spring of the clamping device is clamped between the wedge and the pressure piece.

19. The adjusting device as claimed in claim 18, wherein
two conical half-shells form the wedge.

20. The adjusting device as claimed in claim 19, wherein
the wedge has a bore through which the guide linkage is guided.

21. The adjusting device as claimed in claim 18, wherein
the wedge has a bore through which the guide linkage is guided.

22. The adjusting device as claimed in claim 13, further comprising:
a bearing device with a bearing slot in which the worm section is received.

23. The adjusting device as claimed in claim 13, further comprising:
the worm and/or the worm wheel, wherein
the worm is mounted so as to be able to oscillate in a self-aligning bearing.

24. An electromechanical auxiliary power steering system, comprising:
a motor;
a steering linkage; and
an adjusting device which couples the motor and the steering linkage, the adjusting device comprising:
a worm on a worm wheel of a worm gear;
a guide linkage;
a pressure piece;
a spring which is shaped so as to exert a spring force onto the guide linkage in order to radially push the guide linkage towards the worm;
wherein the guide linkage is configured to transmit the spring force onto the pressure piece,
wherein the pressure piece, which is connected to the guide linkage, is configured to contact a worm section of the worm in order to exert an adjusting force, which is produced by the spring force, onto the worm; and
a clamping device configured to prevent the guide linkage from moving back away from the worm.

25. A method for automatically adjusting a worm on a worm wheel of a worm gear for an electromechanical auxiliary power steering system for a vehicle, the method comprising the steps of:
exerting a spring force of a spring on a guide linkage in order to push the guide linkage radially to the worm;
transmitting the spring force from the guide linkage to a pressure piece connected to the guide linkage;
contacting the pressure piece with a worm section of the worm in order to exert an adjusting force, produced by the spring force, onto the worm; and
preventing the guide linkage from moving back away from the worm
